(19) United States
(12) Patent Application Publication
(10) Pub. No.: US 2007/0219897 A1
(43) Pub. Date: Sep. 20, 2007

(54) System and method for evaluating trade execution

(75) Inventors: Douglas Link Costa, Bala Cynwyd, PA (US); Kai Huang, Gladwyne, PA (US)

Correspondence Address: KENYON & KENYON LLP, 1500 K STREET N.W., SUITE 700, WASHINGTON, DC, 20005, US

(73) Assignee: Susquehanna International Group, LLP

(21) Appl. No.: 11/374,095

(22) Filed: Mar. 14, 2006

(51) Int. Cl. G06Q 40/00

(52) U.S. Cl. 705/37; 705/36 R

(57) ABSTRACT

A method and system for evaluating the execution of a trade of n shares from among a total of N shares of a security traded in a selected time period. According to one embodiment, a trader determines a single share price variance of the N shares, determines a correction coefficient for adjusting the single share price variance to represent a multi-share price variance, determines an adjusted variance by multiplying the single share price variance by the correction coefficient, and evaluates trade execution performance based on the adjusted variance.

### BACKGROUND OF THE INVENTION

Securities trades are frequently executed by human traders or by computerized programs that act as traders. Typically the trader (whether human or automated) will receive a request or “order” to buy or sell a number of shares of a security, and the trader will then execute the trade in a market. In many cases, securities trades cannot be executed in one transaction between a buyer and seller. Instead, they must be executed through two or more transactions over a given time period, for example over hours or days. (As used herein, the term security is construed broadly, and may include various properties such as stocks, bonds, commodities, and the like, as well as options, calls, futures, etc. of such properties. The term share is intended to include any single trading unit including, for example, a lot.)

It is frequently understood that there is a tension between the market impact of executing a trade quickly, and the risk involved in executing a trade more slowly. Different trading strategies (e.g., different timing and volume of transactions in a trade) could result in a greater or lower average price for the trade. Even if a securities trade is executed in a single transaction, there can be differing prices depending on the timing of the transaction, or differing prices compared to various multi-transaction strategies.

One issue resulting from this variability is the question of how well a trade is executed; in other words, how the average price for the trade compares to some other baseline price. This determination can be useful in understanding the efficiency of a trader or trading strategy over time, relative to other traders or trading strategies. Such information, for example, would allow buyers and sellers of securities to make an informed selection between traders or trading strategies.

Up to now, certain trades have been compared to simple baseline numbers such as a daily starting price for the security, or the volume weighted average price (“VWAP”) of the security over a selected time period. These measurements are inexact, however, in that they fail to account for systematic factors such as the volatility of prices associated with the security. Systems that have attempted to account for such factors as price volatility, on the other hand, use computerized sampling algorithms to compare an executed trade with a randomized sample of possible trades over a selected time period. Unfortunately, such systems require protracted simulations of sample distributions to better approximate the distribution of all possible trades over the selected time period. This process is time-consuming, hardware-intensive, and tends to yield inexact results due to the nature of the approximation.

Accordingly, there is a need in the art for a system and method that evaluates the efficiency of trade execution in an accurate and efficient manner.

### BRIEF DESCRIPTION OF THE DRAWINGS

FIG. 1 is a block diagram that depicts a mathematical formulation in accordance with an embodiment of the present invention.

FIG. 2 is a flow chart that depicts a method for evaluating trade execution in accordance with an embodiment of the present invention.

FIG. 3 is a flow chart that depicts a method for further evaluating trade execution in accordance with an embodiment of the present invention.

FIG. 4 is a block diagram that depicts a computer system in accordance with an embodiment of the present invention.

### DETAILED DESCRIPTION

In accordance with the present invention, a more accurate and efficient way for evaluating trade execution may be accomplished by utilizing a multi-share price variance that is based on the multiplication of a single share price variance by a correction coefficient, as represented by equation (1):

$$\begin{matrix}Multi \text{-} Share \\ Price Variance\end{matrix} = \begin{matrix}Single Share \\ Price Variance\end{matrix} \times \begin{matrix}Correction \\ Coefficient\end{matrix} \qquad ( 1 )$$

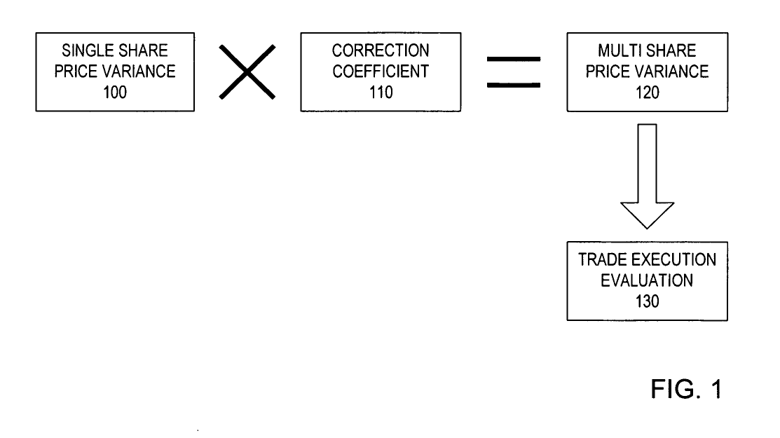

The use of a multi-share variance (i.e., a variance based on sample trades involving more than one share per trade) in a trade execution evaluation is beneficial because it accounts for systemic factors such as price volatility associated with a security. As shown in FIG. 1, however, and unlike previous methods for determining a multi-share variance for use in a trade execution evaluation, embodiments of the present invention determine a multi-share price variance 120 based on a one-time product of two readily determinable values: a single share price variance 100 (i.e., a variance based on sample trades involving one share per trade), and a correction coefficient 110 for adjusting the single share price variance to represent a multi-share price variance. The resulting multi-share price variance 120 can then be utilized in a trade execution evaluation 130. This formula is extensible because any methodology for determining a single share price variance 100 may be utilized, as may any variant of the correction coefficient 110, in any combination.

With respect to the embodiments described herein, N shares represent a market volume during a selected time period T; these N shares may be divided into price groups of nₜ shares, where nₜ represents the shares that are transferred at a given price Pₜ during the time period T. The sum of all nₜ is equal to N. Mathematically, this may be represented by equation (2):

N=Σnₜ (2)

Additionally, this universe of N transferred shares has a VWAP represented by equation (3):

$$VWAP = \frac{\sum {n}_{t} {P}_{t}}{\sum {n}_{t}} \qquad ( 3 )$$

where ΣnₜPₜ represents a summation of the product nₜPₜ for all pairs of nₜ and Pₜ.

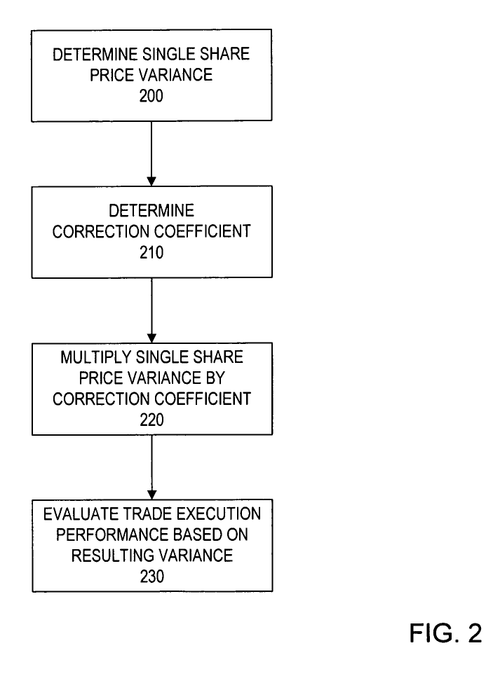

FIG. 2 illustrates a process for evaluating trade execution based on a multi-share price variance determined by equation (1). The process comprises determining a single share price variance (step 200) and a correction coefficient (step 210), multiplying them together (step 220) and evaluating trade execution performance based on the resulting variance (step 230).

In connection with step 200, the single share price variance may be determined to reflect either an actual or an estimated variance of a distribution of prices corresponding to each traded share of a security over a selected time period, as illustrated in the following embodiments.

Regarding an actual single share price variance embodiment, an actual single share price variance may be determined using complete data for a given relevant time period. The variance of the distribution of single share prices may be represented by equation (4):

$$\begin{matrix}Actual Single Share \\ Price Variance\end{matrix} = \sum \frac{{n}_{t}}{N} {( {P}_{t} - \frac{\sum {n}_{t} {P}_{t}}{N} )}^{2} \qquad ( 4 )$$

Regarding an estimated single share price variance embodiment, an estimated single share price variance may be determined using historical volatility and trading statistics. For example, a normalized historical volatility σₕᵢₛₜ for a security over a specified number of days (such as 30, 60 or 90 days) may be calculated or looked up, as shown, for example, in J. Hull, Options, Futures and other Derivative Securities, 3rd Ed., p. 233. Using such parameters, the estimated single share price variance may be represented by equation (5):

$$\begin{matrix}Estimated Single Share \\ Price Variance\end{matrix} = {σ}_{hist}^{2} \cdot T \cdot \frac{{P}_{0}^{2}}{6} \qquad ( 5 )$$

where T is the time period measured in years, and P₀ is the starting price associated with time period T. In addition to choosing a value of P₀ associated with a past time period T for evaluating past trade execution performance, a future value of P₀ may be chosen for predicting future trade execution performance.

Regarding another estimated single share price variance embodiment, an estimated single share price variance may be determined using two real-time data points corresponding to a Geometric Brownian Motion process. For example, a single share price variance may be estimated based on selected trade data for the time period in question, as shown in equation (6):

$$\begin{matrix}Estimated Single Share \\ Price Variance\end{matrix} = \frac{π}{8} {( Ln ( \frac{High}{Low} ) )}^{2} \cdot \frac{{P}_{0}^{2}}{6} \qquad ( 6 )$$

where High is the highest price observed in the time period, Low is the lowest price observed in the time period, and P₀ is the starting price in the time period. In addition to choosing a value of P₀ associated with a past time period T for evaluating past trade execution performance, a future value of P₀ may be chosen for predicting future trade execution performance.

In connection with step 210, a correction coefficient may be determined that adjusts the single share price variance to represent a multi-share price variance.

Regarding a multiple share trade price variance, if a trade of a given security includes nₜ shares of a security, and during the given relevant time period T there are N shares of the security traded on the market as a whole, then a distribution may be constructed by taking all of the possible combinations of nₜ shares of the universe of N shares and prices.

Thus, a distribution may be constructed by taking all possible arbitrary combinations of nₜ shares from the N shares. Because different possible combinations of nₜ shares will encompass different price groups or portions of price groups, the various possible combinations will have various associated volume weighted average prices. The variance of the distribution of these associated volume weighted average prices may be obtained by multiplying the single share price variance (e.g., as represented by equations (4), (5) or (6)) by a correction coefficient.

In accordance with an embodiment of the invention, the correction coefficient may be represented by equation (7):

$$Correction Coefficient = \frac{N - {n}_{t}}{{n}_{t} ( N - 1 )} \qquad ( 7 )$$

Equation (7) may also be represented in the form of Equation (8):

$$Correction Coefficient = \frac{\frac{1}{α} - 1}{N - 1} \qquad ( 8 )$$

where α is equal to the fraction nₜ/N, i.e., the fraction of volume represented by the trade. In this equation alpha is limited to the range from 1/N ( corresponding to a distribution of one share trades) to 1 (corresponding to a distribution of all N shares traded), allowing one to think in terms of trades as a percent of total volume traded in accordance with common practice.

In accordance with another embodiment of the invention, the correction coefficient may be represented by equation (9):

$$Correction Coefficient = \frac{V - {n}_{t}}{{n}_{t} ( V - 1 )} \qquad ( 9 )$$

where V is equal to the historical average daily volume (ADV) or median daily volume (MDV) scaled to the appropriate time period. The value V may represent a more typical or representative value than N in certain cases.

In connection with step 220, the determined single share price variance is multiplied by the determined correction coefficient, resulting in an adjusted variance that may be utilized in a trade execution evaluation as shown by step 230.

The multiplication of the single share price variance by the correction coefficient allows for the comparison of trades of different sizes and participation rates (i.e., a trader's percentage of market volume N during a given time period). For any number nₜ between 1 and N, the multiplication of the single share price variance by the correction coefficient results in a price variance somewhere between zero (when nₜ=N) and the single share price variance (when nₜ=1). It is also noted that the participation rate is inversely proportional to the price variance from the VWAP—the greater the participation rate, the lower the price variance from the VWAP, and the lower the participation rate, the greater the price variance from the VWAP.

The trade execution evaluation may involve the determination of an efficiency score based on the adjusted variance and other factors, such as actual weighted average price and benchmark price. For example, certain volatile securities may tend to create large differences (either positive or negative) between the weighted average price of a trade and the benchmark price, relative to the differences typically resulting from trades of less volatile securities. The standard deviation σ, which may be calculated by taking the square root of the adjusted variance, will tend to increase with more volatile securities compared to less volatile securities. By scaling these differences according to the standard deviation σ, the relative efficiency of trade executions may be more accurately compared between volatile and non-volatile securities. Likewise, the standard deviation σ will tend to reflect any unusual volatility (or lack thereof) for a particular security or the market as a whole. By scaling according to the standard deviation σ, the efficiency score of an execution of a trade will not be impacted by such events.

In accordance with an embodiment of the invention, the efficiency score may be determined using any useful function of the actual weighted average price, the benchmark price, and the standard deviation σ based on the adjusted variance. For example, the difference between the actual weighted average price and the benchmark price may be scaled according to standard deviation σ to produce a z-score for the trade. A z-score may be determined by equation (10):

$$z \text{-} score = \frac{Actual Price - Benchmark Price}{σ} \qquad ( 10 )$$

As understood in the art, the z-score constitutes the “number” of standard deviations a given value lies along a distribution. For example, if the actual weighted average price of a trade is 7, and the benchmark price is 4, and the standard deviation σ of a trade is 1, then the z-score of the trade will be 3. A trade having an actual weighted price of 20, a benchmark price of 8, and a standard deviation σ of 4 will have the same z-score of 3.

For determining an actual weighted average price Pₐᵥₑ of the trade (corresponding to the “Actual Price” on the right hand side of equation (10)), if a trade of nₜ shares of a security is executed in a single transaction at a price Pₜ, then the actual weighted average price Pₐᵥₑ will be equal to Pₜ. Alternatively, if the trade is executed in multiple transactions, then a weighted average may be calculated according to equation (11):

$${P}_{ave} = \frac{( {n}_{t 1} {P}_{t 1} + {n}_{t 2} {P}_{t 2} + {n}_{t 3} {P}_{t 3} + … + {n}_{t i} {P}_{t i} )}{{n}_{t}} \qquad ( 11 )$$

where nₜ₁ is the number of shares exchanged at price Pₜ₁, where nₜ₂ is the number of shares exchanged at price Pₜ₂, and so on. In equation (10), the sum {nₜ₁+nₜ₂+nₜ₃ . . . +nₜᵢ} is equal to nₜ, the total number of shares in the executed trade. Equation (10) provides a weighted average price for the nₜ shares of the trade, as executed.

For determining a benchmark price of the security (corresponding to the “Benchmark Price” on the right hand side of equation (10)), the benchmark price may be any value useful for comparison with the actual weighted average price. For example, the benchmark price may be the volume weighted average price (“VWAP”) of the security for a given relevant time period. As understood in the art, the VWAP price represents a volume weighted average for all transactions of a security in a selected time period. The selected time period may be any useful time period, such as a time period beginning when the order for the trade is received by a trader (whether a human trader or automated trading system), and ending when the trade execution is completed. Alternatively, the selected time period may end at some other selected time such as the daily close of trading.

Additionally, the benchmark price may be the starting price of a security for a selected time period. For example, the benchmark price may be the price of the security when the order for the trade is received by a trader, or the opening price of the security at the start of daily trading, etc.

The benchmark price may also be adjusted according to a market movement factor for the selected time period. Any useful market movement factor may be utilized to form the benchmark price, such as a percentage gain or loss of the market as a whole for the selected time period. This may be, for example, the percentage gain or loss for an entire day, or a percentage gain or loss for a time period beginning when the trader receives the order for the trade, and ending at some selected time as described above.

Further, the market factor may be applied to a VWAP to form an adjusted VWAP. Any useful function of the VWAP and market factor may be employed. For example, if the market factor is a percentage of market movement, then the VWAP may be adjusted by the same percentage to obtain the adjusted VWAP. Similarly, the market factor may be applied to a starting price to obtain an adjusted starting price. Any useful function of the starting price and market factor may be employed, such as a percentage adjustment.

Embodiments of the present invention may utilize trades of a single security or with trades of multiple securities. In a multiple-security trade, each security in the trade may be treated individually, according to the embodiments described above. In other words, transactions involving each individual security may be tracked separately from transactions of other securities in the trade. Likewise, transactions of that security within the market as a whole may be tracked separately from transactions of other securities. In this manner, the equations above may be applied to produce an individual z-score or other efficiency score for each individual security in the trade.

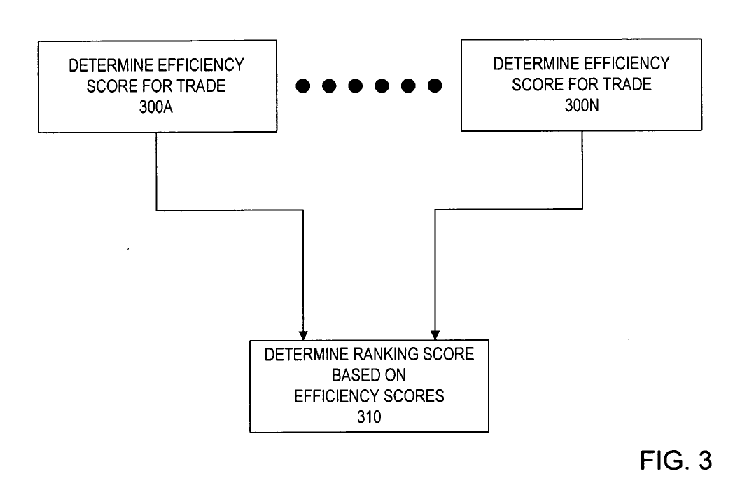

As illustrated in FIG. 3, once the individual efficiency scores or z-scores have been determined (steps 300a-300n), they may be used to generate an overall score, or ranking score, for the trade, trader (whether human or automated) or trading strategy (step 310). For example, the overall efficiency score may be an unweighted average of the individual efficiency scores, or may be a weighted average of the individual efficiency scores (for example weighted according to the number of shares of each individual security in the trade, or according to the total price of all shares of each individual security in the trade, or other useful weight).

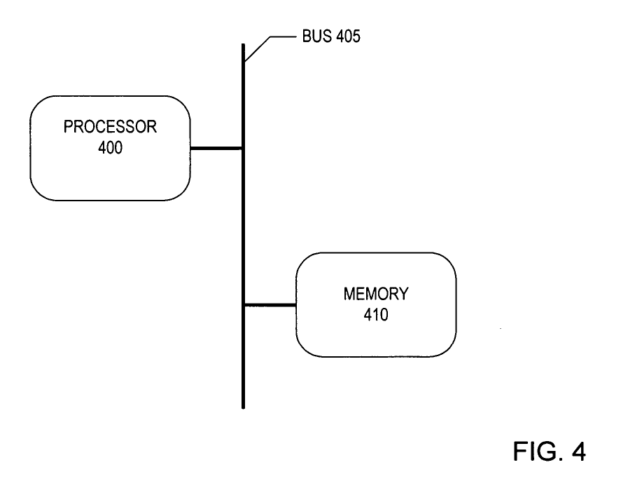

FIG. 4 illustrates a computer system in accordance with the present invention, which includes a processor 400 running software that may implement any of the above-described methods and steps, and a memory 410. Processor 400 and memory 410 may, for example, be connected through a local bus 405. The computer system may be implemented across a distributed system or network, in which processor 400, memory 410, and/or other parts of the computer system are geographically or topographically distributed, for example over a Local Area Network, Wide Area Network, the Internet, or other network or communication link.

In accordance with an embodiment of the invention, processor 400, which may include any useful processor as understood in the art, may run software such as Excel, SAS, Matlab, S-Plus and R to determine the single share price variance, correction coefficient, and/or the adjusted variance resulting from the product of the two as described above. The software may perform the determinations described above using relevant data, which may be input directly from an external source (such as a keyboard, touch screen, network interface, etc.) or may be provided from memory 400, which may include any type of computer storage. Processor 400 may also evaluate trade execution performance by determining an efficiency score based on the adjusted variance as described above.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for evaluating execution of a trade of nₜ shares from among a total of N shares of a security traded in a selected time period T, comprising:
determining a single share price variance of the N shares;
determining a correction coefficient for adjusting the single share price variance to represent a multi-share price variance;
determining an adjusted variance by multiplying the single share price variance by the correction coefficient; and
evaluating trade execution performance based on the adjusted variance.

2. The method of claim 1, wherein evaluating trade execution performance comprises:
determining an efficiency score based on the adjusted variance.

3. The method of claim 1, wherein the single share price variance represents a variance of a distribution of prices corresponding to each of the N traded shares.

4. The method of claim 3, wherein the adjusted variance represents a variance of a distribution of average prices corresponding to each possible subset of nₜ traded shares from among the N traded shares.

5. The method of claim 1, wherein the correction coefficient is determined according to the formula:
$$\frac{N - {n}_{t}}{{n}_{t} ( N - 1 )}$$

6. The method of claim 1, wherein the correction coefficient is determined according to the formula:
$$\frac{\frac{1}{α} - 1}{N - 1}$$
where α corresponds to nₜ/N.

7. The method of claim 1, wherein the correction coefficient is determined according to the formula:
$$\frac{V - {n}_{t}}{{n}_{t} ( V - 1 )}$$
where V corresponds to an average daily volume or median daily volume of traded shares.

8. The method of claim 7, wherein V is scaled to fit the selected time period.

9. The method of claim 3, wherein the single share price variance represents an actual variance.

10. The method of claim 9, wherein the actual variance is determined according to the formula:
$$\sum \frac{{n}_{t}}{N} {( {P}_{t} - \frac{\sum {n}_{t} {P}_{t}}{N} )}^{2}$$
where nₜ corresponds to the shares traded at price Pₜ, and N=Σnₜ.

11. The method of claim 3, wherein the single share price variance represents an estimated variance.

12. The method of claim 11, wherein the estimated variance accounts for historical volatility.

13. The method of claim 12, wherein the estimated variance is determined according to the formula:
$${σ}_{hist}^{2} \cdot T \cdot \frac{{P}_{0}^{2}}{6}$$
where σₕᵢₛₜ corresponds to a normalized historical volatility over a specified time period, T corresponds to a time period measured in years, and P₀ corresponds to a starting price associated with time period T.

14. The method of claim 13, wherein the specified time period of the normalized historical volatility includes a number of days.

15. The method of claim 14, wherein the number of days includes one of the group consisting of: 30 days, 60 days, and 90 days.

16. The method of claim 12, wherein the estimated variance is determined according to the formula:
$${σ}_{hist}^{2} \cdot T \cdot \frac{{P}_{0}^{2}}{6}$$
where σₕᵢₛₜ corresponds to a normalized historical volatility over a specified time period, T corresponds to a time period measured in years, and P₀ corresponds to a starting price associated with a future time period.

17. The method of claim 11, wherein the estimated variance is derived from an assumption of a Geometric Brownian Motion process.

18. The method of claim 17, wherein the estimated variance is determined according to the formula:
$$\frac{π}{8} {( Ln ( \frac{High}{Low} ) )}^{2} \cdot \frac{{P}_{0}^{2}}{6}$$
where High corresponds to a highest price observed in the selected time period T, Low corresponds to a lowest price observed in the selected time period T, and P₀ corresponds to a starting price in the time period T.

19. The method of claim 17, wherein the estimated variance is determined according to the formula:
$$\frac{π}{8} {( Ln ( \frac{High}{Low} ) )}^{2} \cdot \frac{{P}_{0}^{2}}{6}$$
where High corresponds to a highest price observed in the selected time period T, Low corresponds to a lowest price observed in the selected time period T, and P₀ corresponds to a starting price associated with a future time period.

20. The method of claim 2, wherein the efficiency score is determined by a function of an actual weighted average price, a benchmark price, and a standard deviation based on the adjusted variance.

21. The method of claim 20, wherein the benchmark price includes a VWAP of the security for the selected time period.

22. The method of claim 20, wherein the benchmark price includes a starting price of the security for the selected time period.

23. The method of claim 20, wherein the benchmark price includes an adjusted VWAP of the security for the selected time period, the adjusted VWAP being a function of a VWAP for the selected time period and a market movement factor for the selected time period.

24. The method of claim 20, wherein the benchmark price includes an adjusted starting price of the security for the selected time period, the adjusted starting price being a function of a starting price for the selected time period and a market movement factor for the selected time period.

25. The method of claim 23, wherein the market movement factor includes a percentage gain or loss of the market as a whole for the selected time period.

26. The method of claim 24, wherein the market movement factor includes a percentage gain or loss of the market as a whole for the selected time period.

27. The method of claim 20, wherein the efficiency score includes a z-score determined according to the formula:
$$\frac{Actual Price - Benchmark Price}{σ}$$
where σ corresponds to the standard deviation, and the standard deviation corresponds to the square root of the adjusted variance.

28. The method of claim 2, wherein evaluating trade execution performance further comprises:
determining a ranking score based on the efficiency score based on the adjusted variance in combination with one or more other efficiency scores associated with other trades.

29. The method of claim 27, wherein the ranking score is an unweighted average of the plurality of efficiency scores.

30. The method of claim 27, wherein the ranking score is a weighted average of the plurality of efficiency scores.
